(19) United States
(12) Patent Application Publication
(10) Pub. No.: US 2022/0081160 A1
(43) Pub. Date: Mar. 17, 2022

(54) A Lifting Apparatus

(71) Applicant: Stephen Thomas MARSH, Bournemouth, Dorset (GB)

(72) Inventor: Stephen Thomas MARSH, Bournemouth, Dorset (GB)

(21) Appl. No.: 17/420,601

(22) PCT Filed: Jan. 20, 2020
(86) PCT No.: PCT/IB2020/050411

§ 371 Date: Jul. 2, 2021

(30) Foreign Application Priority Data
Jan. 21, 2019 (GB) 1900814.3

(51) Int. Cl. B65D 19/38; B66C 1/16

(52) U.S. Cl. CPC B65D 19/385; B66C 1/16

(57) ABSTRACT

The present invention relates to a lifting apparatus, in particular a modular lifting apparatus that can be assembled about an item to be lifted. The lifting apparatus has at least two elongate bars connected and spaced apart by at least two spacers; and at least four end plates that are fitted to ends of the elongate bars using a locking mechanism.

Each elongate bar passes through or under an item to be lifted and projects from each end of the item to be lifted; each spacer is shaped and dimensioned to have a portion that extends to abut the item to be lifted and prevent the spacer moving along the elongate bars, and the spacer has a pair of eyes, each eye receives an end of an elongate bar.

Each end plate is locked to the elongate bar by the locking mechanism thereby fixing the spacer in position; and each end plate includes a means for engaging with a lifting device.

### FIELD OF THE INVENTION

The present invention relates to a lifting apparatus, in particular a modular lifting apparatus that can be assembled about an item to be lifted, which provides support across the length, width or diameter of the item.

### BACKGROUND

Often a pallet stacked with an item or items is lifted using a forklift or tele-lift to ensure support across the length of the load being lifted. If such equipment is not available or suitable for a particular location, other lifting methods may be used, such as using grab or lifting hoist.

However, often the alternative methods employed do not meet the necessary health and safety requirements and as such an organisation may be in breach of its statutory health and safety obligations.

### PRIOR ART

https://www.raahsafety.com Raah International PVT Ltd provides a pair of pallet bars that pass through a pallet and are not directly connected to one another in any way.

JP2009269708 (SAKAMOTO discloses a pallet hanger.

JP2008260570 (FUJITA) discloses a tool for lifting pallets.

In contrast the present invention provides a lifting apparatus, that when assembled, forms a rigid support frame.

### SUMMARY OF THE INVENTION

According to the present invention there is provided a lifting apparatus that is assembled to form a frame comprising: at least two elongate bars connected and spaced apart by at least two spacers; and at least four end plates that are fitted to ends of the elongate bars using a locking mechanism; wherein each elongate bar passes through or under an item to be lifted and projects beyond the item to be lifted; each spacer is shaped and dimensioned to have a portion that extends to abut the item to be lifted and to prevent the spacer moving with respect to the elongate bars, and the spacer has a pair of eyes, each eye receives an end of an elongate bar; each end plate is locked to the elongate bar by the locking mechanism thereby fixing the spacer in position; and each end plate includes a means for engaging with a lifting device.

In this way the apparatus provides a modular lifting apparatus that is assembled to form a strong, stable and safe lifting apparatus for moving an item or plurality of items. In particular the apparatus is suitable for use with pallets and other containers or platforms which require support across the length, width or diameter of the item, or items, during lifting.

Advantageously the apparatus is modular and so can be easily assembled and disassembled about the item to be lifted so that the apparatus can be fitted or removed to the item to be lifted whilst it is in situ.

In use, the elongate bars pass through a channel on the item to be lifted, for example through a pallet or container, or under an item to be lifted. In this way the lifting apparatus provides a frame that bears weight across it, for example across the item(s). Advantageously this meets the safety requirement for lifting items or equipment that cannot be lifted safely from only an edge but requires support across an entire underside of the item, such as is the case when lifting pallets.

Each elongate bar passes through or under an item to be lifted and projects from each end or edge of the item to be lifted. In this way the ends of the elongate bar are accessible for arranging and fitting the spacers and end plates. Advantageously this also improves safety of lifting, as an operator can assemble the apparatus without having to pass their hands under or through the item to be lifted so avoiding inadvertent crushing. Also an operator is able to view the locking mechanism, prior, during and after lifting, to ensure all its parts are correctly assembled.

Different lengths of elongate bars may be provided depending upon the size, shape and nature of item(s) to be lifted.

Ideally the elongate bars are hollow. Advantageously this reduces the weight of the apparatus whilst maintaining strength.

Preferably the elongate bars are formed from box sections, for example a length of steel box section. In this way the elongate bars can be readily fitted into a box shaped channel and will not roll or turn.

Spacers engage with the elongate bars to ensure that the elongate bars are correctly positioned to provide a frame upon which the load to be lifted can be evenly spread and thereby acts to maintain the frame, when assembled, square at all times.

Each spacer is shaped and dimensioned to have a portion that extends to abut the item to be lifted and to prevent the spacer moving along the elongate bars. Preferably at least part of the spacer extends upwards to form a barrier that is parallel to an edge of the item to be lifted. In this way the spacer limits movement of the item to be lifted.

The weight of the item also tends to prevent movement of the spacer inwards along the elongate bars.

Each spacer is an elongate member, preferably formed from box section, with an eye at each end for receiving the elongate bar. The eyes of the spacers are configured and arranged to pass over each pair of ends of the elongate bars such that the bars are parallel and may be set at a fixed distance from one another. Preferably each eye is shaped and dimensioned to correspond to the exterior cross section of the elongate bar, so that the eyes fit snugly over the elongate bar ends limiting movement between the parts and thus reducing wear.

In some embodiments the elongate bars may also have a node projecting from an outer face which serves to prevent the spacer moving along the length of the elongate bar.

The spacers are formed from a strong durable material providing a strong brace between at least two parallel bars. Spacers of different lengths, or with eyes at different positions, may be provided so that the bars can be spaced apart at predefined distances that correspond to the item to be lifted.

The end plates, once fitted to ends of the elongate bars, prevent displacement of the spacers. The end plates are locked in place to fix the spacers in position and thereby provide a lifting point.

Preferably the end plates fit to ends of the elongate bars by way of a twist lock mechanism in which the end plate has a key that is received by an aperture (keyhole) on the end of the elongate bar. The key is inserted into the aperture/keyhole and turned so as to lock the end plate to the elongate bar.

It is appreciated that different locking mechanism may be used, for example interlocking or screw fitted parts.

Preferably the keyhole (or aperture) is formed within a plate that is welded to an open end of the elongate bar.

Ideally the plate is at least 25 mm thick and has a central aperture with a pair of opposed lobes that extend from the central aperture. In this way the length of the opening is greater than the width due to the positioning of the lobes.

Preferably the keyhole length is at least 70 mm and ideally 72 mm and the keyhole width is at least 40 mm and ideally 47 mm.

Typically the keyhole is cut in the plate and the plate is welded to or within the elongate bar end.

Preferably the outer edge of the keyhole is chamfered to enable weld penetration. Preferably the chamfered surface is at least 4 mm and ideally at least 5 mm.

Preferably the key is shaped and dimensioned to lock the end plate and elongate bar tightly together so that there is limited or no movement between the parts. This ensures that the apparatus, when assembled, is substantially rigid and does not move or twist during lifting.

Preferably the key has a key body and at least one tine. The key body is preferably rounded so as allow the key to be easily turned when inserted to the aperture (keyhole) of the elongate bar.

In a preferred embodiment, to form the end plate, a slot is cut out of the plate for receiving an anchoring end of a key. Ideally the slot is at least 30 mm deep and the width of the slot corresponds to the diameter of the anchoring end of the key. Preferably the anchoring end is attached to the end plate within the slot by means of a weld.

Preferably a rectangular slot is cut into the end plate that corresponds to the diameter of the cylindrical anchoring end of the key body. Preferably the slot is deeper than the width of the anchoring end to provide strong and secure attachment. For example the slot may be 25 mm wide×30 mm deep. This configuration enables end plates to be easily formed from component parts that are welded together.

The tines project from the key body. Preferably a pair of opposed tines are provided to project radially from the key body. Typically the tines may be plates that are welded to the key body.

In a preferred embodiment the key body has a diameter of 25 mm. The tines are plates welded to the key body that are, for example, 20 mm×10 mm and project radially from opposed sides of the key body.

In other embodiments each end of the bar is open and the key is adapted to correspond to the cross section of the elongate bars, such that the key fits concentrically within the bar and is locked in place by a hole and pin configuration. Advantageously multiple holes may be provided so that the position of the end plate on the bar can be adjusted to change how far the end plate projects.

Each end plate has a means for engaging with a lifting device. The means for engaging with a lifting device is formed on the end plate and may include, but are not limited to, a lifting aperture, a lip for engaging with a grab on a lifting device or a textured surface for engaging with lifting equipment.

It is appreciated that the means for engaging with a lifting device may be shaped and dimensioned to receive different lifting equipment, such as a hook, shackle, tine of a lifting apparatus such as a digger bucket or forklift, strop, cable or other attachment part.

The lifting means is configured to be easily accessed by a user once locked in position.

Ideally part of the end plate which includes a lifting means, extends above the elongate bars (once locked in position), so as to present the lifting means to a user for easy connection to lifting equipment or other attachment means. In this way the user does not have to reach under the end plate to connect lifting connectors and can easily connect the lifting apparatus to the lifting equipment.

In preferred embodiments the end plate has at least one textured surface for engaging with a lifting device. Advantageously this helps to provide a secure gripping surface to prevent any slippage during lifting.

In some embodiments the lifting apparatus is provided with a retaining clip which is provided to keep the end plate (when fitted) in an upright position. The retaining clip is arranged on the apparatus to ensure that the end plate, once engaged with the elongate bar, is maintained in an upright position. This makes it easy for a user who is lifting the apparatus with a grab, as it is important that the end plates are in a fixed position.

It is appreciated that the retaining clips may not be used when connecting the end plates to lifting equipment such as to a hook through the lifting eye as the connection of parts would be a manually assembled and once connected the end plates would move to the upright position by the action of being lifted.

In a preferred embodiment the retaining clip has an arm which is located in a hollow region of the spacer and a bracket that fits about and engages with the end plate to hold it in position. The bracket is arranged to extend perpendicular from the arm and to engage with the end plate so that it is held in an upright position.

Preferred embodiments of the invention will now be described, by way of example and with reference to the Figures in which:

### BRIEF DESCRIPTION OF FIGURES

FIG. 1A shows a lifting apparatus arranged on a pallet;

FIG. 1B shows a top view of the lifting apparatus and pallet shown in FIG. 1A;

FIG. 1C shows an end view of the lifting apparatus and pallet shown in FIG. 1A;

FIG. 1D shows a side view of the lifting apparatus and pallet shown in FIG. 1A;

FIG. 2A shows an end view of the elongate bar;

FIG. 2B shows a top view of the elongate bar;

FIG. 2B shows a side view of the elongate bar;

FIG. 2D shows and overview of the elongate bar;

FIG. 3A shows a side view of a spacer;

FIG. 3B shows an end view of the spacer;

FIG. 3C shows a top view of the spacer;

FIG. 3D shows an overview of the spacer;

FIG. 4A shows an end view of an end plates;

FIG. 4B shows a side view of the end plate;

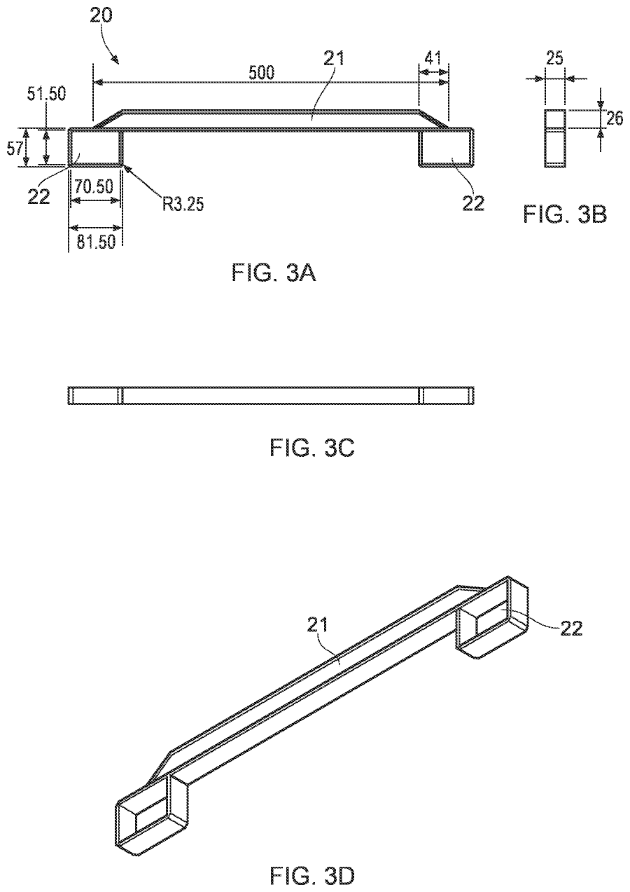

FIG. 3C shows an overview of the end plate;

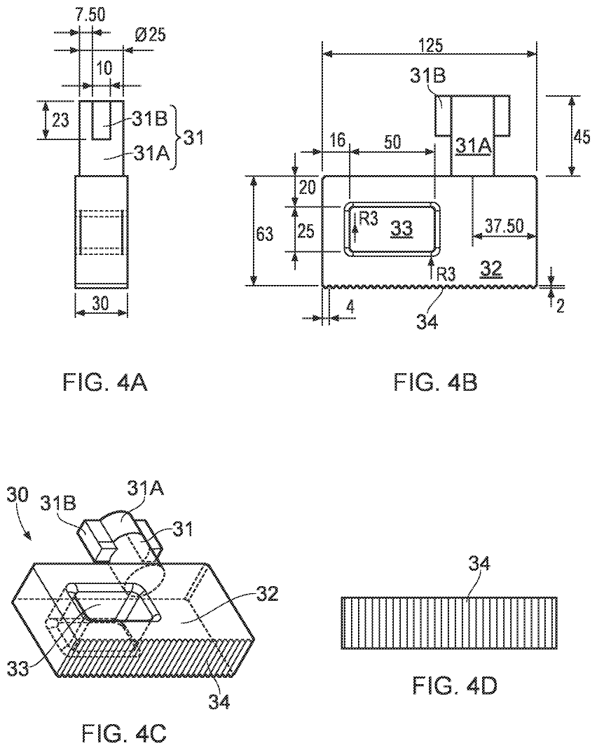

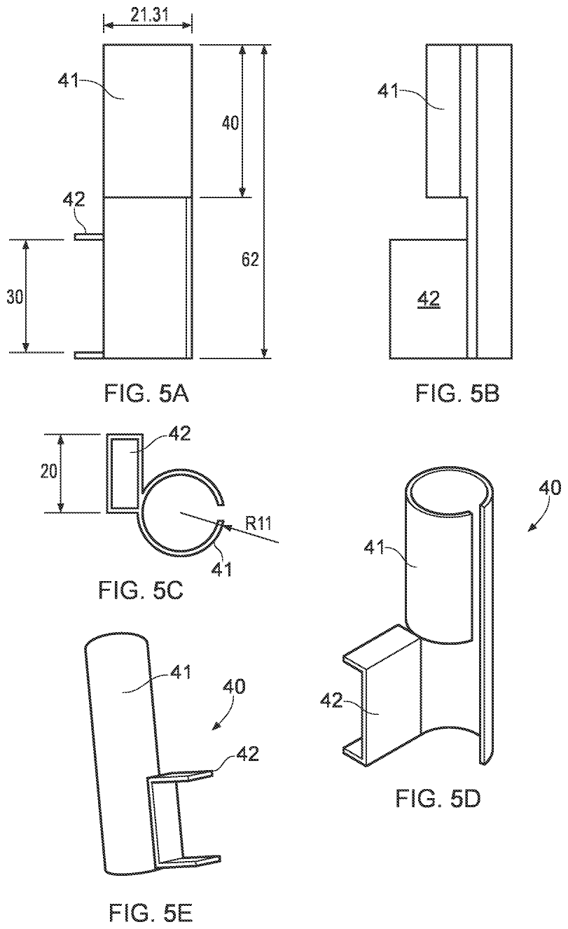

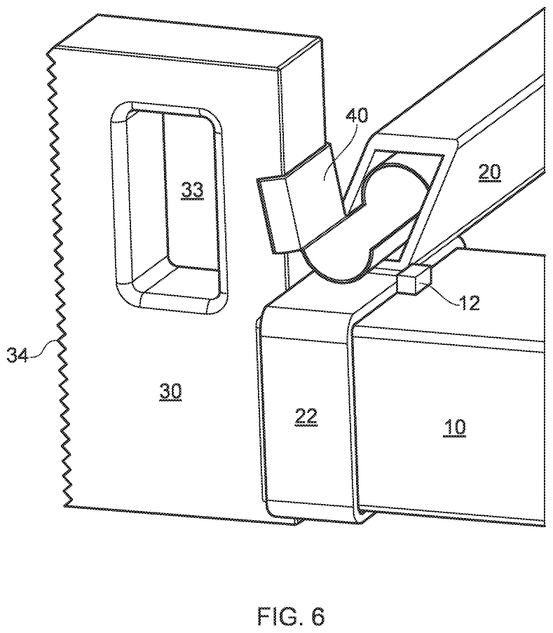

FIG. 4D shows end view of the end plate;

FIG. 5A shows a side view of a retaining clip;

FIG. 5B shows a top view of the retaining clip;

FIG. 5C shows an end view of the retaining clip;

FIG. 5D shows an overview of the retaining clip;

FIG. 5E shows an overview of a second embodiment of a retaining clip; and

FIG. 6 shows the retaining clip in use.

### DETAILED DESCRIPTION OF FIGURES

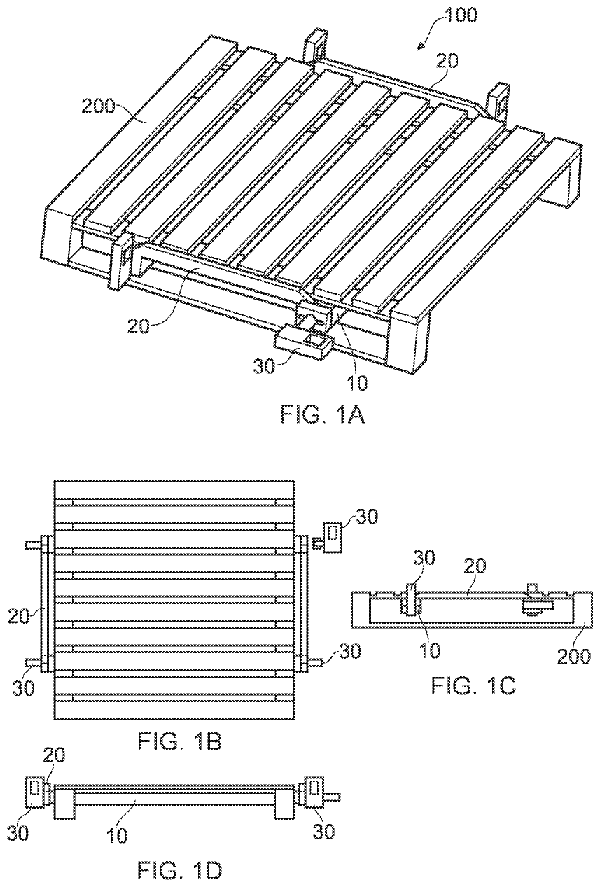

FIGS. 1 to 4 show a preferred embodiment of the lifting apparatus and views of individual parts of the lifting apparatus. Like parts have the same references.

FIGS. 1A to 1D show the lifting apparatus 100 in use, arranged on a pallet 200. The elongate bars 10 pass through an underside of the pallet 200. The two elongate bars 10 are joined together by two spacers 20 and the spacers 20 are locked in place by the end plates 30.

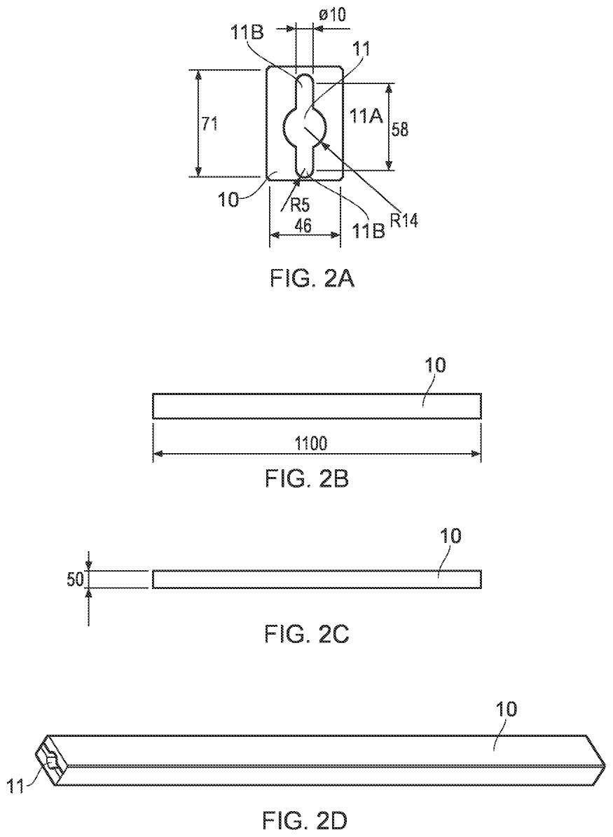

An example of an elongate bar is shown in FIGS. 2A to 2D. The elongate bars 10 are formed from box section and are therefore hollow. The box section is rectangular so that in use the long side contacts the item to be lifted to provide a larger contact surface area.

The elongate bars are preferably at least 1100 mm long, preferably 1127 mm long, with a section width of at least 71 mm, preferably 75 mm and a depth of at least 45 mm and preferably 50 mm. Preferably the internal opening of the elongate bars is 72 mm×47 mm.

Longer elongate bars may be provided for larger loads, such as for plasterboard and sheet timber wherein the elongate bar may be at least 1500 mm and preferably 1575 mm.

It is appreciated that the elongate bars and the spacers may be provided in various different sizes to create frames to accommodate different loads.

Each end of the elongate bar 10 is partially closed with an opening 11 in the form of a keyhole for receiving part of the end plate 30. The opening/keyhole 11 is shaped to receive a key 31 on the end plate 30. The keyhole 11 has a central circular portion 11A with a pair of opposed lobes 11B such that the opening is longer than it is wide.

Each elongate bar with an external cross section of 75 mm×50 mm is preferably closed at each end by a plate that is 72 mm long×47 mm wide×25 mmm thick. The plate has an opening 11 for receiving the key 31. The plate fits within the internal cross section of the elongate bar and is welded into place.

The key 31 can only be inserted in a particular orientation into the opening 11. Once inserted the key 31 is turned to lock the end plate 30 to the elongate bar 10 and to present part of the end plate 30 with the lifting means in an orientation to which it can easily be connected to, or received by, lifting equipment.

Both ends of the elongate bars 10 have openings 11, so that end plates 30 are locked to each end of the elongate bars 10.

The entrance of the opening 11 is preferably chamfered around the perimeter edge to allow for weld penetration.

An example of the spacers 20 is shown in FIGS. 3A to 3D. The spacer 20 is a metal member 21 with an eye 22 at each end. Each eye 22 is rectangular to correspond to the shape of the elongate bar 10.

In preferred embodiments the metal member is formed from box section, although in some embodiments it may be solid.

For example the elongate member 21 may be formed from 25 mm×25 mm box section that is 2 mm thick.

Typically, the metal member 21 is welded or bonded to the eyes 22. The eyes 22 are offset from the member 21 wherein the member extends upwards in use, so that the member 21 can abut the item to be lifted and so that the spacer 20 is below the member 21 in use.

The eyes 22 may be formed from sections of box section or flat bar that has been folded to form an eye. Preferably the eyes are also a thickness of 2 mm with a width of 25 mm. The opening defied by eyes corresponds to the cross section of the elongate bars.

In a preferred embodiment the eye opening is 85 mm×55 mm for receiving elongate bars with an external cross section of 75 mm×50 mm.

The elongate bars 10 have a node 12 that the spacer 20 abuts and is prevented from moving further along the elongate bar 10. The node therefore acts to maintain alignment.

The node 12 may be a plate welded to the exterior surface of the elongate bar 10. For example a square plate 20 mm×20 mm may be welded to the elongate bar.

FIGS. 4A to 4D show an example of an end plate 30. The end plate 30 has a key 31 projecting from a face. The key 31 is inserted into the opening 11 of the elongate bar. The body 32 of the end plate 30 has a lifting aperture 33 through which a lifting tool such as a hook (not shown) is inserted.

The key 31 has a key body 31A and a pair of tines 31B. The tines 31B are rectangular plates welded to the key body 31A. The tines 31B project radially from the key body 31A and are arranged to be opposed to each other. The tines 31B correspond to the lobes 11B of the keyhole 11.

The lifting aperture 33 is positioned on the body 32 so that when the key 31 is turned the lifting aperture 33 is upright and projects higher than the elongate bars 10. In this way the lifting aperture 33 or lifting means 34 are easily accessible to a user.

On a face of the body 32 opposed to the key 31, the face has a textured surface 34 which provides a lifting means. The textured surface is formed from raised and lower portions that form ridges to help lifting equipment engage with the end plate. The textured surface may be an alternative or additional lifting means. For example, a grab may contact the ridged surface.

In preferred embodiments the end plate dimensions are 65 mm wide×125 mm high and 25 mm thick.

The lifting aperture has preferred dimensions of 25 mm×50 mm which define a rectangular hole.

FIGS. 5A, 5B, 5C, 5D and 6 show a preferred embodiment of a retaining clip 40. The retaining clip 40 is positioned on the spacer 20 once the spacer 20 is locked in position by the end plate 30.

The retaining clip 40 has an arm 41 and a bracket 42.

The arm is an elongate C-section and has a bracket 42 that extends perpendicular from the arm 41. The bracket 42 is U-shaped and corresponds to the shape of a side of the end plate (30) shown in FIGS. 4A to 4D. The shape of the bracket 42 ensures that the end plate 30 is held in a fixed position when the apparatus is assembled.

In another embodiment the arm is a continuous tube that has a bracket welded to an exterior surface of the arm (see FIG. 5E). This embodiment reduces the machining time required to create the part. The arm is inserted to the hollow elongate bar of the spacer and is then rotated until the bracket receives the end plate.

If the spacer member is solid an opening must be provided, or at least part of the member must be hollow to receive the retaining clip.

The bracket is dimensioned to correspond to the thickness of the end plate so that when the end plate is in the upright position, ready for lifting, the endplate is held in the upright orientation by the clip.

In a preferred embodiment the clips 40 may be anodised to help provide resistance to wear and to reduce corrosion.

FIG. 6 also shows a node 12 that projects from the elongate bar 10. The node is a square portion which prevents the spacer 20 from sliding along the elongate bar 10. Thus maintaining formation of the apparatus and providing the optimal configuration during lifting.

The invention has been described by way of examples only and it will be appreciated that variation may be made to the above-mentioned embodiments without departing from the scope of the invention as defined by the claims.

1. A lifting apparatus that is assembled to form a frame comprising:
at least two elongate bars connected and spaced apart by at least two spacers; and
at least four end plates that are fitted to ends of the at least two elongate bars using a locking mechanism;
wherein each of the at least two elongate bars passes through or under an item to be lifted and projects beyond the item to be lifted;
each spacer is shaped and dimensioned to have a portion that extends to abut the item to be lifted and to prevent the spacer moving with respect to the at least two elongate bars, and the spacer has a pair of eyes, each eye receives an end of one of the at least two elongate bars;
each of the at least four end plates is locked to the respective one of the at least two elongate bars by the locking mechanism thereby fixing the spacer in position; and
each of the at least four end plates includes a means for engaging with a lifting device.

2. The lifting apparatus according to claim 1, wherein the at least four end plates are fitted to a respective one of the at least two elongate bars by a twist lock mechanism.

3. The lifting apparatus according to claim 1, wherein the at least four end plates has a key that fits concentrically within a respective one of the at least two elongate bars and is locked in place by a hole and pin configuration.

4. The lifting apparatus according to claim 1, wherein the at least two elongate bars are hollow.

5. The lifting apparatus according to claim 4, wherein the at least two elongate bars are formed from box section.

6. The lifting apparatus according to claim 1 wherein the means for engaging with the lifting device comprise at least one end plate having a lifting aperture.

7. The lifting apparatus according to claim 1 wherein the means for engaging with the lifting device comprise at least one end plate having a lip for engaging with a grab on the lifting device.

8. The lifting apparatus according to claim 1 wherein the means for engaging with the lifting device comprise at least one end plate having a textured surface on at least one face for engaging with the lifting device.

9. The lifting apparatus according to claim 1 wherein the member of the spacer is formed from box section.

10. The lifting apparatus according to claim 1, wherein the member of the spacer is formed from a solid material.

11. The lifting apparatus according to claim 1, further comprising:
a retaining clip.

12. The lifting apparatus according to claim 1 wherein the at least two elongate bars each include at least one node.
